(19) United States
(12) Patent Application Publication
(10) Pub. No.: US 2002/0073260 A1
(43) Pub. Date: Jun. 13, 2002

(54) Method for preventing processes between processors from conflicting in a multiprocessor based computer

(76) Inventors: Kuang-Shin Lin, Taipei (TW); Tong-S Chen, Taipei (TW)

Correspondence Address: BACON & THOMAS, PLLC, 625 Slaters Lane - 4th Floor, Alexandria, VA, 22314-1176, US

(21) Appl. No.: 09/733,999

(22) Filed: Dec. 12, 2000

(51) Int. Cl. G06F 13/14

(52) U.S. Cl. 710/200; 710/240

(57) ABSTRACT

An integral semaphore is set as lock label which is in turn placed in a code segment of process control block of respective processor in a multiprocessor based computer, thus identifying whether system resources is occupied by a processor. The lock label is placed if system resources is not occupied by the processor. Then the processor is commanded to perform an interrupt service routine thereof. The lock label is released after the interrupt service routine has been finished, thereby enabling other processors to utilize the system resources. The processor may normally perform its interrupt process procedure when an interrupt signal is received sequentially. Thus, it is possible to prevent processes between processors from conflicting in measuring the number of processors.

### FIELD OF THE INVENTION

The present invention relates to the processes performed by multiprocessor and more particularly to a method for preventing processes between processors from conflicting in a multiprocessor based computer.

### BACKGROUND OF THE INVENTION

Conventionally, processes between processors tend to conflict one another in a multiprocessor based computer. As such, a correct measurement of the number of processors is not possible. Thus, it is desirable to provide a method to overcome the above drawback of prior art.

### SUMMARY OF THE INVENTION

In one aspect of the present invention, a method for preventing processes between processors from conflicting in a multiprocessor based computer comprising the steps of (a) setting an integral semaphore as lock label, (b) identifying whether system resources is occupied by a first processor, (c) placing the lock label if system resources is not occupied by the first processor, (d) instructing the first processor to perform an interrupt service routine thereof, (e) releasing the lock label after the interrupt service routine has been finished, and (f) permitting a second processor to sequentially utilize system resources for performing an interrupt service routine thereof.

It is an object of the present invention to set an integral semaphore as lock label for ensuring a plurality of processors in a computer to sequentially perform a process thereof so as to prevent processes between processors from conflicting. Thus, release the lock label after the process has been finished. Next, system returns to the status before interrupted. As such, other processors may sequentially utilize system resources for performing an interrupt service routine thereof. As a result, the disk operating system (DOS) may maintain a normal operation after a multiprocessor module has been finished.

It is another object of the present invention to place the integral semaphore in code segment of process control block of respective processor. Code segment is not varied as process proceeds. As such, data in data segment and stack segment may be stored in advance before the processor performs the interrupt service routine. The stored address is in the code segment. As a result, the processor may correctly find data after the interrupt process has been finished in order to return to the status before interrupted.

The above and other objects, features and advantages of the present invention will become apparent from the following detailed description taken with the accompanying drawings.

### BRIEF DESCRIPTION OF THE DRAWINGS

FIG. 1 is a block diagram of the processes according to the method of the invention;

FIG. 2 is a flow chart illustrating the processes performed by the main processor shown in FIG. 1;

FIG. 3 is a flow chart illustrating the processes performed by the auxiliary processor according to the invention; and

FIG. 4 is a flow chart illustrating the processes performed by the starting address module shown in FIG. 2.

### DETAILED DESCRIPTION OF THE PREFERRED EMBODIMENTS

In an Intel based multiprocessor main board, a main processor having a local advanced programmable interrupt control (APIC) is provided. Main processor acts to communicate messages and commands among multiprocessor systems. Main processor may send an interrupt signal to the specified auxiliary processor when the interrupt signal is received from any of other processors through system bus. As such, the auxiliary processor may process the interrupt. Main processor on the multiprocessor main board may issue a special interrupt when DOS embedded on the multiprocessor main board receives a special interrupt. Thus, auxiliary processor is commanded to sequentially perform an interrupt service routine so as to check the interrupt signal and call a specified interrupt processing program. Then the interrupt is processed. Also, the current status is stored in memory. It is known that only one processor is allowed to perform an interrupt service routine at one time in DOS environment. In this manner, the invention comprises the steps of (a) setting an integral semaphore as lock label, (b) the lock label identifying whether system resource is occupied by a first processor, (c) performing an interrupt service routine; (c) placing the lock label if system resources is not occupied by the first processor, (d) instructing the first processor to perform the interrupt service routine, (e) releasing the lock label after the interrupt service routine has been finished, and (f) permitting a second processor to sequentially utilize system resources for performing an interrupt service routine thereof.

In the invention each processor on the multiprocessor main board has its own process needed to be performed. Each process is corresponding to a process control block in memory. Data segment and stack segment of one process control block are different from that of another process control block. In a conventional design, an integral semaphore label is placed in data segment. However, data in the data segment may vary as process proceeds. As such, other processors may not find the integral semaphore label, thus neutralizing the system. In overcoming above drawback, the invention places the integral semaphore label in code segment of process control block of respective processor. Code segment is not varied as process proceeds. As such, data in data segment and stack segment may be stored in advance before the processor performs the interrupt service routine. The stored address is in the code segment. As a result, the processor may correctly find data after the interrupt process has been finished in order to return to the status before interrupted.

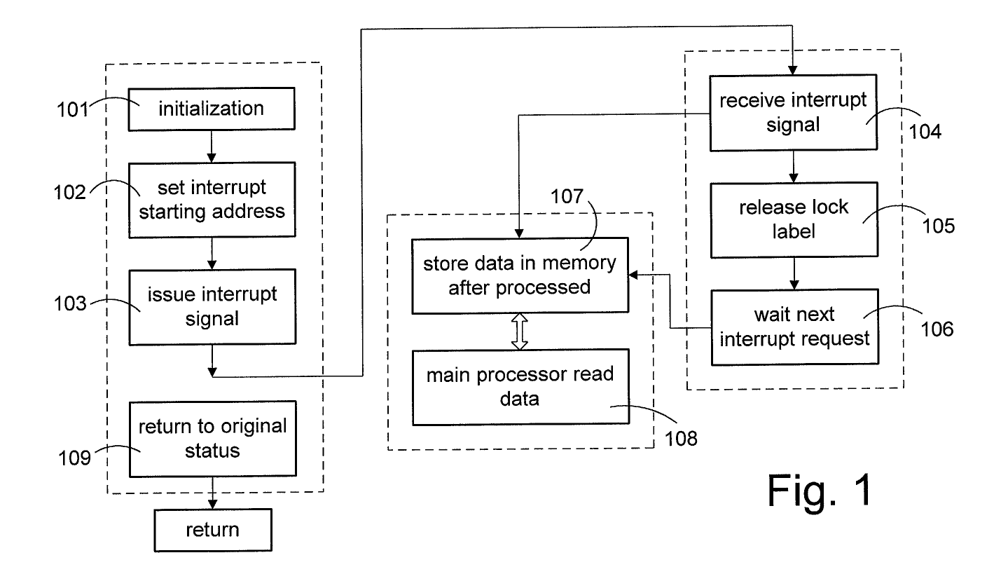

FIG. 1 is a block diagram of the processes according to the method of the invention. These are performed after multiprocessor main board is activated and a boot-up process of DOS is finished.

In block 101, an initialization of main processor is performed by system.

In block 102, interrupt starting address of each auxiliary processor is set by main processor.

In block 103, issue an interrupt signal to each auxiliary processor sequentially.

In block 104, an interrupt vector in memory (addressed at 40:67) is used when an interrupt signal is received by auxiliary processor. A corresponding interrupt procedure is performed by auxiliary processor based on the address of interrupt service routine in the interrupt vector. As such, address of the corresponding interrupt service routine performed by auxiliary processor is required to place in interrupt vector at 40:67 in memory. Thus, auxiliary processor may find a corresponding interrupt service routine through interrupt vector and perform the same for completing the processing of the interrupt. Each auxiliary processor may utilize the lock label of the invention to identify the current occupied system resources as in a state of performing the interrupt process procedure.

In block 105, release the lock label after the interrupt process procedure has been finished.

In block 106, wait a next interrupt request. With this, it is possible for other processors to sequentially utilize system resources for performing an interrupt service routine.

In block 107, the current status of an auxiliary processor is stored in memory when an interrupt signal is received by the auxiliary processor. As such, the lock label may be released after all processors have finished the processing of interrupt.

In block 108, main processor may correctly find the status data of each auxiliary processor before interrupted based on data stored in memory. As a result, in block 109, each auxiliary processor may return to the status before interrupted after the interrupt process has been finished.

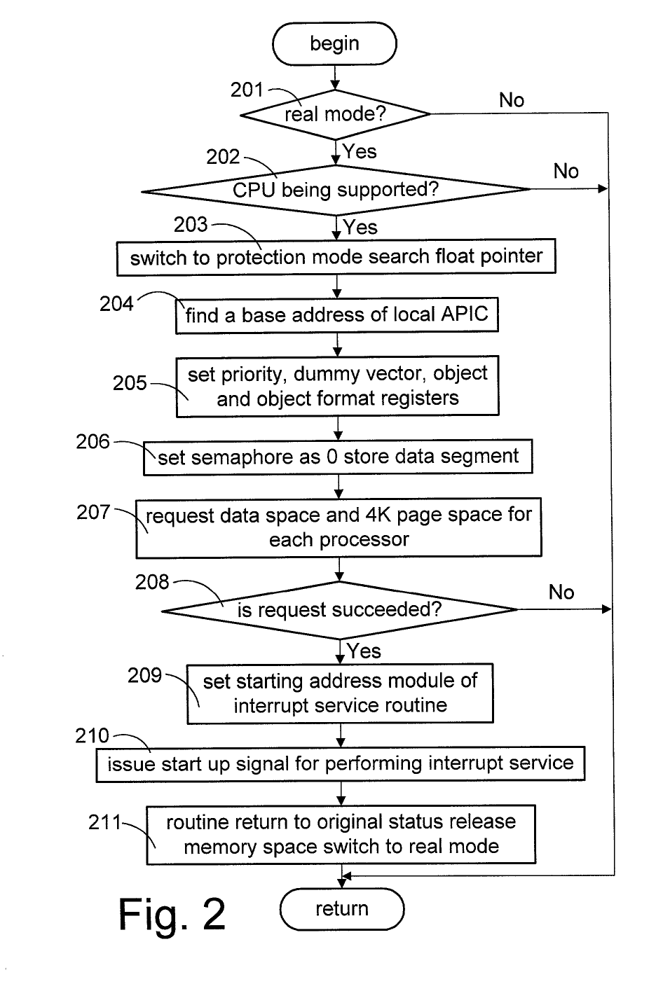

FIG. 2 is a flow chart illustrating the processes performed by the main processor shown in FIG. 1.

In step 201, main processor determines whether the current mode is a real mode. In not (i.e., the current mode is a protection mode), process ends. If yes, process goes to step 202.

In step 202, determine whether ID of main processor is a processor above Pentium processor. If not, process ends. If yes, process goes to step 203.

In step 203, switch current mode to protection mode.

In step 204, search a float pointer in order to find a base address of local APIC.

In step 205, set a priority register, a dummy vector register, an object register, and an object format register at that base address. Set a corresponding semaphore for each auxiliary processor ready to process.

In step 206, set the value of corresponding semaphore as 0. Store the data segment thereof.

In step 207, request a data space and a 4K page space for each processor. The 4K page space is a required memory space for processor to perform.

In step 208, determine whether the request is succeeded. If not, perform ends. If yes, process goes to step 209.

In step 209, set a starting address module of interrupt service routine.

In step 210, issue a start up signal to instruct auxiliary process to perform the interrupt service routine.

In step 211, after the interrupt service routine has been finished, return to the system environment before interrupted. Then release memory space. Finally, switch to real mode for waiting a next cycle.

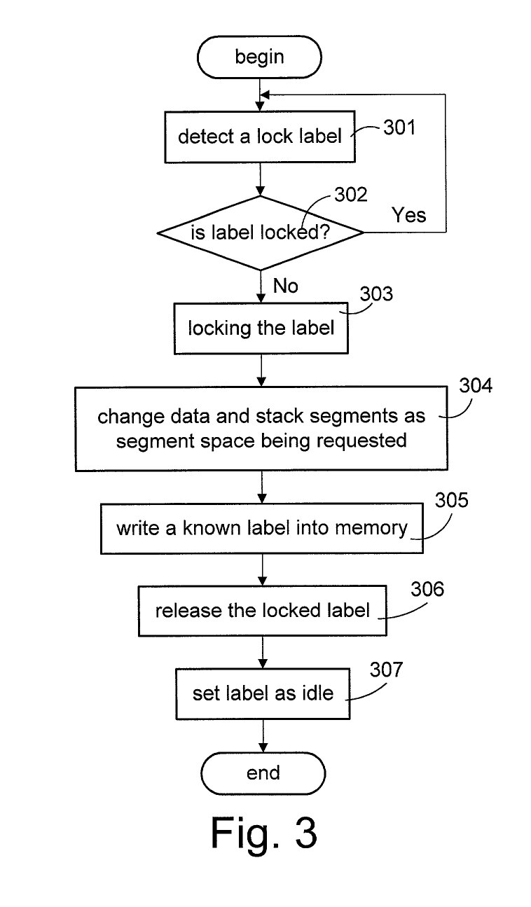

FIG. 3 is a flow chart illustrating the processes performed by the auxiliary processor for identifying the current system resources occupied status by utilizing the lock label of the invention.

In step 301, detect a lock label.

In step 302, determine whether the label has been locked. If yes, process loops back to step 301. If not, process goes to step 303.

In step 303, perform a locking on the label.

In step 304, change data segment and stack segment as segment space being requested.

In step 305, write a known label into a corresponding segment space in memory. As such, main processor may correctly read the status data of auxiliary processor before interrupted from memory.

In step 306, release the locked label after the interrupt process procedure has been finished.

In step 307, set the label as idle such that other processors may sequentially utilize system resources for performing an interrupt service routine.

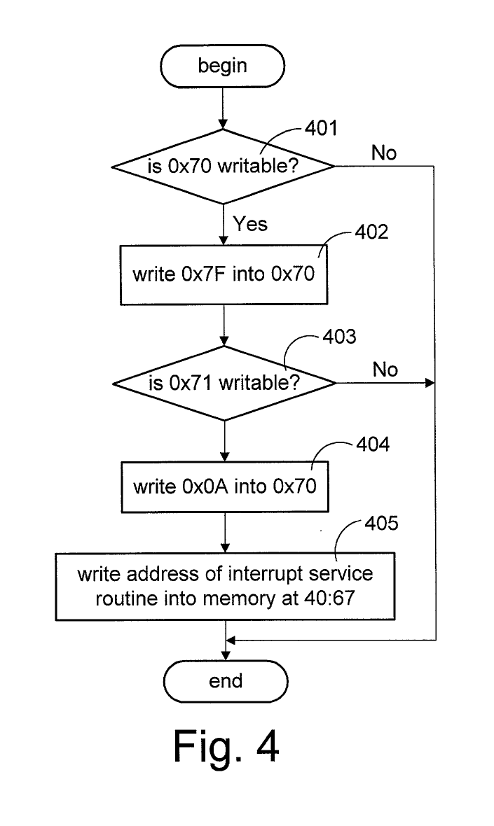

FIG. 4 is a flow chart illustrating the processes performed by the starting address module of interrupt service routine.

In step 401, determine whether starting address at 0x70 is writable or not. If not, process ends. If yes, process goes to step 402.

In step 402, write 0x7F into the starting address at 0x70.

In step 403, determine whether starting address at 0x71 is writable or not. If not, process ends. If yes, process goes to step 404.

In step 404, write 0x0A into the starting address at 0x70.

In step 405, write the address of interrupt service routine into memory address 40:67.

In the code segment of the invention, an integral semaphore is set as lock label. As such, processor may cyclically detect whether the label set by the integral semaphore is locked when processor performs an interrupt service routine. If yes, command the processor to continue detecting in a wait state. If not, lock the label and perform an interrupt service routine. Then release the lock label after the interrupt service routine has been finished. As a result, other processors may sequentially perform an interrupt service routine thereof.

In this manner, in measuring the number of processors in a multiprocessor based computer, each processor may normally perform its interrupt process procedure when an interrupt signal is received sequentially. Thus, it is possible to prevent processes between processors from conflicting. As a result, the DOS may maintain a normal operation after a multiprocessor module has been finished.

While the invention has been described by means of specific embodiments, numerous modifications and variations could be made thereto by those skilled in the art without departing from the scope and spirit of the invention set forth in the claims.

What is claimed is:

1. A method for preventing processes between a main and a plurality of auxiliary processors from conflicting in a multiprocessor based computer comprising the steps of:
(a) setting an integral semaphore as a lock label,
(b) placing the lock block in a code segment of a process control block of respective processor in the multiprocessor based computer,
(c) identifying whether system resources is occupied by a first processor,
(d) placing the lock label if the system resources is not occupied by the first processor,
(e) instructing the first processor to perform an interrupt service routine thereof,
(f) releasing the lock label after the interrupt service routine has been finished, and
(g) enabling a second processor to utilize the system resources such that the second processor is capable of performing an interrupt process procedure thereof when an interrupt signal is received sequentially.

2. The method of claim 1, further comprising initializing a main processor having a local advanced programmable interrupt control (APIC) in the multiprocessor, commanding the main processor to set an interrupt starting address of each auxiliary processor, and sequentially sending an interrupt signal to each auxiliary processor.

3. The method of claim 2, further comprising using an interrupt vector in memory when the interrupt signal is received by the auxiliary processor whereby the auxiliary processor performs the corresponding interrupt process procedure based on the address of the interrupt service routine in the interrupt vector.

4. The method of claim 3, wherein each auxiliary processor utilizes the lock label to identify the current occupied system resources as in a state of performing the interrupt process procedure, whereby release the lock label after the interrupt process procedure has been finished and wait a request of a next interrupt.

5. The method of claim 2, wherein the current status of each auxiliary processor is stored in the memory when the interrupt signal is received by the auxiliary processor, whereby release the lock label after the auxiliary processor has finished processing the interrupt, the main processor correctly find the status data of each auxiliary processor before interrupted based on data stored in the memory, and ensure each auxiliary processor to return to the status before interrupted after finishing processing the interrupt.

6. The method of claim 2, wherein after the main processor has determined a current mode is a real mode, the method determines whether the identification (ID) of the main processor is complied with a predetermined requirement and switches the current mode to a protection mode if the result is positive, the method further comprising the steps of:
(h) searching a float pointer for finding a base address of the local APIC,
(i) setting a priority register, a dummy vector register, an object register, and an object format register at that base address,
(j) setting a corresponding semaphore for each auxiliary processor ready to process,
(k) setting the value of the corresponding semaphore as 0 and storing a data segment thereof,
(l) requesting a data space and an operation space for each processor,
(m) determining whether the request is succeeded, and
(n) setting a starting address module of the interrupt service routine and issuing a start up signal if the result in step (m) is positive.

7. The method of claim 6, wherein the multiprocessor is returned to the status before interrupted, the memory is released, and the multiprocessor is switched to the real mode for waiting a next cycle after the interrupt service routine has been finished.

8. The method of claim 2, wherein the step of each auxiliary processor utilizing the lock label to identify the current occupied system resources further comprising the step of (o) detecting a lock label, determining whether the label has been locked, and either looping back to the step (o) if the result is positive or performing a lock on the lock label, the method further comprising the steps of:
(p) changing a data segment and a stack segment as a segment space being requested,
(q) writing the lock label into a corresponding segment space in the memory such that the main processor is capable of correctly reading the status data of the auxiliary processor before interrupted from memory,
(r) releasing the lock label after the interrupt process procedure has been finished, and
(s) setting the lock label as idle such that the second processor is capable of sequentially utilizing the system resources for performing the interrupt service routine.
